(19) United States
(12) Patent Application Publication
(10) Pub. No.: US 2026/0266764 A1
(43) Pub. Date: Sep. 10, 2026

(54) CALIBRATION TEST PIECE FOR EDDY CURRENT TESTING

(71) Applicants: KAORI HEAT TREATMENT CO., LTD., Taoyuan City (TW); NATIONAL ATOMIC RESEARCH INSTITUTE, Taoyuan City (TW)

(72) Inventors: YAO-CHUN HUANG, Taoyuan City (TW); CHIA-PIN CHO, Taoyuan City (TW); SHENG-LONG JENG, Taoyuan City (TW); CHIEN-CHOU LEE, Taoyuan City (TW)

(73) Assignees: KAORI HEAT TREATMENT CO., LTD., Taoyuan City (TW); NATIONAL ATOMIC RESEARCH INSTITUTE, Taoyuan City (TW)

(21) Appl. No.: 19/280,142

(22) Filed: Jul. 25, 2025

(30) Foreign Application Priority Data
Mar. 6, 2025 (TW) 114108327

(51) Int. Cl. G01N 27/90

(52) U.S. Cl. CPC G01N 27/9006

(57) ABSTRACT

This application provides a calibration test piece for eddy current testing, including: a metal base plate; a metal wavy finned sheet, welded on the metal base plate, where the metal wavy finned sheet includes a plurality of metal crests and a plurality of metal troughs, and the plurality of metal crests and the plurality of metal troughs respectively extend in parallel along an extension direction parallel to the metal base plate; and a calibration test pattern, formed between the metal wavy finned sheet and the metal base plate, where in an area of the calibration test pattern, the metal wavy finned sheet and the metal base plate are in an abnormal welding state. The calibration test pattern has a hypotenuse, and the hypotenuse forms an included angle with the extension direction.

### CROSS-REFERENCE TO RELATED APPLICATION

This non-provisional application claims priority under 35 U.S.C. § 119(a) on Patent Application No(s). 114108327 filed in Taiwan, R.O.C. on Mar. 6, 2025, the entire contents of which are hereby incorporated by reference.

### BACKGROUND OF THE INVENTION

### 1. Field of the Invention

This application relates to a calibration test piece for eddy current testing.

### 2. Description of the Related Art

Regarding a conventional recuperative heat exchanger, in order to realize heat exchange, in practice, a metal wavy finned sheet is arranged between two metal base plates of the recuperative heat exchanger, so that a plurality of ramps are formed between the two metal base plates by using a structure of the metal wavy finned sheet, and thereby, a medium (e.g., water) in the ramps is used for heat exchange.

Regarding the metal base plates, the two metal base plates in the recuperative heat exchanger may be referred to as a first metal base plate (e.g., a top plate) and a second metal base plate (e.g., a bottom plate), and the two metal base plates may specifically be thin plates having a thickness of 2 mm or other thicknesses.

Regarding the metal wavy finned sheet, the metal wavy finned sheet is a kind of wavy metal plate. More specifically, the metal wavy finned sheet has a plurality of metal crests and a plurality of metal troughs, and each of the plurality of metal crests and each of the plurality of metal troughs respectively extend in parallel along a same direction (for example, a direction parallel to a surface where the metal base plate contacts the metal wavy finned sheet), so as to respectively form the parallel and continuous metal crests and the parallel and continuous metal troughs. In addition, the metal crests in the metal wavy finned sheet can be respectively welded to, for example, the first metal base plate, and the metal troughs in the metal wavy finned sheet can be respectively welded to, for example, the second metal base plate, so as to form the plurality of ramps mentioned above.

In order to confirm that the metal wavy finned sheet in the recuperative heat exchanger can play its role, it is often required to test the finished recuperative heat exchanger in practice, that is, to test the welds between the metal wavy finned sheet and the metal base plate. Since these welds are located inside the recuperative heat exchanger and cannot be directly tested by human eyes and these welds must be tested nondestructively, in practice, nondestructive testing methods, such as X-ray photography, ultrasonic testing, magnetic particle inspection and eddy current testing, are needed to detect whether the welds of the finished recuperative heat exchanger are in a normal welding state on the premise of not destructing the welds.

### BRIEF SUMMARY OF THE INVENTION

In view of various nondestructive testing methods, in practice, not all the nondestructive testing method are suitable for testing the weld between the metal wavy finned sheet and a metal base plate. For example, for the X-ray photography, it is not easy for determination because the gaps in an image are too small. Ultrasonic testing is not suitable for surface and/or subsurface inspection. Magnetic particle inspection is not suitable for non-ferromagnetic materials. For the effectiveness of testing, eddy current testing is used in practice to test the aforementioned welds between the metal wavy finned sheet and the metal base plate so as to detect whether the welds are in a normal welding state.

Regarding the eddy current testing, although the eddy current testing is more suitable for testing the aforementioned welds between the metal wavy finned sheet and the metal base plate due to its sensitivity to tiny flaws, test devices involved in an eddy current testing technology often need to set the corresponding parameter values for various finished recuperative heat exchangers to be tested in advance before the subsequent testing operation can be effectively carried out. More specifically, since the finished recuperative heat exchangers may have different configurations according to actual needs, it is required in practice to complete the parameter value setting for the corresponding test device in advance according to the finished recuperative heat exchangers with different configurations, such that the test device can effectively carry out the subsequent testing operation according to the finished recuperative heat exchangers with different configurations.

However, in practice, the parameter value setting before the testing operation is often completed depending on the inspector's experience. In this case, it is not possible to effectively adjust the parameter values based on some objective criteria, and further, it is not possible to effectively carry out the subsequent testing operation.

Therefore, how to solve the above problems in the prior art and effectively improve the efficiency of adjusting parameter values to further improve the speed and accuracy of subsequent testing has become an urgent problem to be solved in the art.

In order to solve the above problems, this application provides a calibration test piece for eddy current testing, including: a metal base plate; a metal wavy finned sheet, welded on the metal base plate, where the metal wavy finned sheet includes a plurality of metal crests and a plurality of metal troughs, and the plurality of metal crests and the plurality of metal troughs respectively extend in parallel along an extension direction parallel to the metal base plate; and a calibration test pattern, formed between the metal wavy finned sheet and the metal base plate. In an area of the calibration test pattern, the metal wavy finned sheet and the metal base plate are in an abnormal welding state. The calibration test pattern has a hypotenuse, and the hypotenuse forms an included angle with the extension direction.

In some embodiments, the calibration test pattern further has a first side and a second side. The first side is parallel to the extension direction, and the second side is perpendicular to the extension direction.

In some embodiments, the calibration test pattern is a triangle.

In some embodiments, the metal base plate is a metal flat plate or a metal bent plate.

In some embodiments, the calibration test piece is used in an eddy current testing procedure of a recuperative heat exchanger.

Thereby, through the technical means provided by this application, beneficial effects that cannot be achieved by the prior art can be produced. Specifically, one of the beneficial effects that can be achieved by this application is that this application can effectively improve the efficiency of adjusting the parameter value setting of the test device and further effectively complete the parameter value setting before the testing operation, so that the speed and accuracy of subsequent testing can also be effectively improved.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a top view of a calibration test piece for eddy current testing according to an embodiment of this application.

FIG. 1B is a side view of the calibration test piece for eddy current testing as shown in FIG. 1A.

FIG. 1C is a schematic partial enlarged view of the calibration test piece for eddy current testing as shown in FIG. 1A.

FIG. 2A is an oscillogram of a testing signal of the calibration test piece for eddy current testing according to an embodiment of this application.

FIG. 2B is an oscillogram of a testing signal of an actual test object according to an embodiment of this application.

FIG. 3A is an oscillogram of a testing signal of the calibration test piece for eddy current testing according to another embodiment of this application.

FIG. 3B is an oscillogram of a testing signal of an actual test object according to another embodiment of this application.

### DETAILED DESCRIPTION OF THE INVENTION

The contents of this application will be described in detail through the following embodiments and accompanying drawings, so as to help those of ordinary skill in the art understand the objectives, features and effects of this application.

It should be noted that, in the contents described in this application, terms such as “first”, “second” and “third” are used to distinguish the differences between components, and are not intended to limit the components themselves or indicate a specific order of the components. In addition, in the contents described below, the same components or steps may be denoted by the same reference signs.

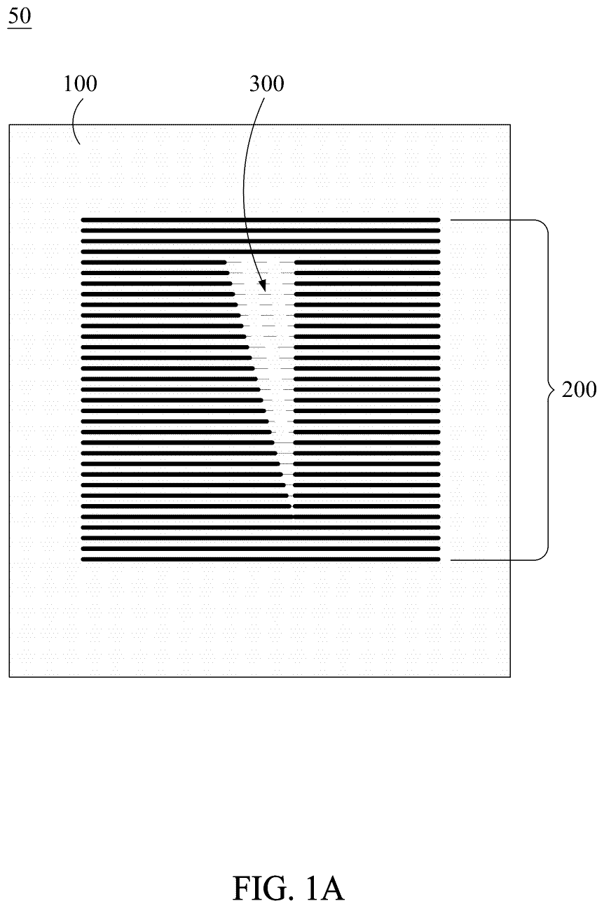

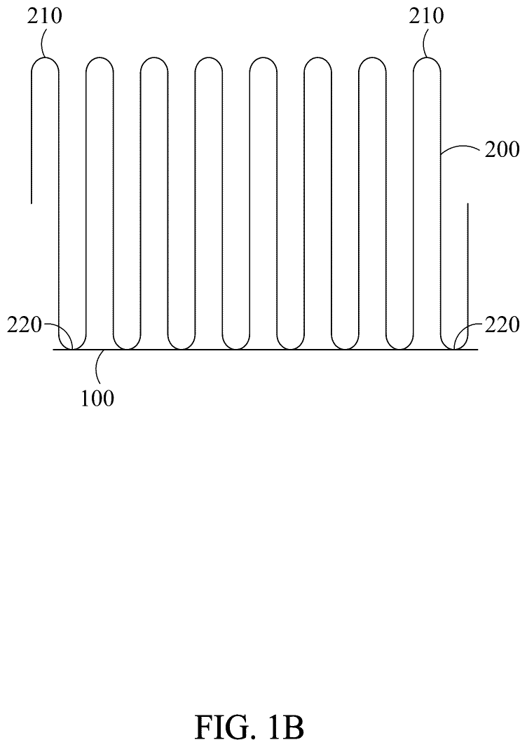

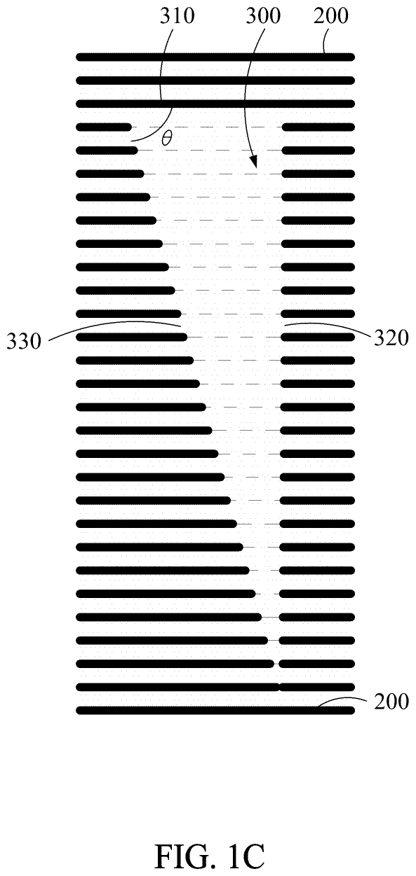

Referring to FIG. 1A, FIG. 1B and FIG. 1C, FIG. 1A is a top view of a calibration test piece 50 for eddy current testing according to an embodiment of this application. FIG. 1B is a side view of the calibration test piece 50 for eddy current testing as shown in FIG. 1A. FIG. 1C is a schematic partial enlarged view of the calibration test piece 50 for eddy current testing as shown in FIG. 1A.

As shown in FIG. 1A, the calibration test piece 50 for eddy current testing includes a metal base plate 100, a metal wavy finned sheet 200 and a calibration test pattern 300. The components will be respectively described in more detail below.

Regarding the metal base plate 100, the metal base plate 100 may specifically be a thin plate, for example, having a thickness of 2 mm or other thicknesses. In some embodiments, a material and/or the thickness of the metal base plate 100 may vary according to the actual finished recuperative heat exchanger to be tested. For example, when a material of a metal base plate of the recuperative heat exchanger to be tested is nickel alloy 800 (Alloy 800), the material of the metal base plate 100 of the calibration test piece 50 is also nickel alloy 800. When the material of the metal base plate of the recuperative heat exchanger to be tested is nickel alloy 625 (Alloy 625), the material of the metal base plate 100 of the calibration test piece 50 is also nickel alloy 625. In other words, the material of the metal base plate 100 of the calibration test piece 50 is the same as the material of the metal base plate of the recuperative heat exchanger to be tested. Similarly, the thickness of the metal base plate 100 of the calibration test piece 50 is also the same as the thickness of the metal base plate of the recuperative heat exchanger to be tested. In some embodiments, the metal base plate 100 may be a metal flat plate in a flat shape. In another embodiments, the metal base plate 100 may also be a metal bent plate in a bent shape.

Regarding the metal wavy finned sheet 200, the metal wavy finned sheet 200 is welded on the metal base plate 100. More specifically, as shown in FIG. 1B, the metal wavy finned sheet 200 has a plurality of metal crests 210 and a plurality of metal troughs 220. Each of the plurality of metal crests 210 and each of the plurality of metal troughs 220 respectively extend in parallel along an extension direction parallel to the metal base plate 100, so as to respectively form the parallel and continuous metal crests 210 and the parallel and continuous metal troughs 220. Taking FIG. 1A as an example, the aforementioned extension direction is a horizontal line direction from left to right or from right to left. In addition, the aforementioned extension direction may also be a straight line direction from top to bottom or from bottom to top. In other words, the aforementioned extension direction may be a direction parallel to a surface where the metal base plate 100 contacts the metal wavy finned sheet 200. As shown in FIG. 1A and FIG. 1B, the parallel and continuous metal troughs 220 in the metal wavy finned sheet 200 are respectively welded on the metal base plate 100 of the calibration test piece 50.

Regarding the calibration test pattern 300, the calibration test pattern 300 is formed between the metal wavy finned sheet 200 and the metal base plate 100. More specifically, the calibration test pattern 300 is formed between the plurality of metal troughs 220 of the metal wavy finned sheet 200 and the metal base plate 100. It should be noted that in order to make the calibration test pattern 300 more clearly presented in the drawing, the metal wavy finned sheet 200 corresponding to an area of the calibration test pattern 300 shown in FIG. 1A is specially lightened. In other words, actually, the metal wavy finned sheet 200 is still present in the area of the calibration test pattern 300 shown in FIG. 1A.

Furthermore, in the area of the calibration test pattern 300, the plurality of metal troughs 220 of the metal wavy finned sheet 200 and the metal base plate 100 are in an abnormal welding state. In the area other than the calibration test pattern 300, the plurality of metal troughs 220 of the metal wavy finned sheet 200 and the metal base plate 100 are in a normal welding state. More specifically, the aforementioned normal welding state means that the weld is in a solid welding state, i.e., the metal troughs 220 can be reliably welded to the metal base plate 100 by welding. In contrast, the aforementioned abnormal welding state means that the metal troughs 220 cannot be reliably welded to the metal base plate 100 by welding, and the abnormal welding state may specifically be, for example, a pseudo welding state, a false welding state, a missing welding state or a state of not being welded. When the plurality of metal troughs 220 of the metal wavy finned sheet 200 and the metal base plate 100 are in the abnormal welding state, two adjacent ramps cannot be effectively separated because the welds are in the abnormal welding state. When the plurality of metal troughs 220 of the metal wavy finned sheet 200 and the metal base plate 100 are in the normal welding state, two adjacent ramps can be effectively separated, which prevents a medium (e.g., water) in the two adjacent ramps from circulating with each other.

As shown in FIG. 1C, the calibration test pattern 300 has a hypotenuse 330, and the hypotenuse 330 forms an included angle θ with the aforementioned extension direction (i.e., the horizontal line direction from left to right or from right to left shown in FIG. 1A). The included angle θ may be any value other than 0 degrees, 90 degrees, 180 degrees and 270 degrees. Since the calibration test pattern 300 has the hypotenuse 330 forming the included angle θ with the aforementioned extension direction, the calibration test piece 50 is more suitable for the parameter value setting process before the testing operation. Furthermore, as shown in FIG. 1C, the calibration test pattern 300 further has a first side 310 and a second side 320. The first side 310 is parallel to the aforementioned extension direction, and the second side 320 is perpendicular to the aforementioned extension direction. Additionally, taking FIG. 1A and FIG. 1C as an example, the calibration test pattern 300 is a triangle. In addition, in other embodiments, the calibration test pattern 300 may also be in the geometric shape of various polygons such as a rhombus, a pentagon or a hexagon.

Since the calibration test piece 50 has the metal base plate 100 and the metal wavy finned sheet 200 that are substantially the same as the finished recuperative heat exchanger to be tested and the calibration test pattern 300 is formed between the metal base plate 100 and the metal wavy finned sheet 200, after the calibration test piece 50 is subjected to eddy current testing, a qualified area and an unqualified area will be produced. Therefore, the tester may perform eddy current testing by using the calibration test piece 50 so as to determine whether the parameter value setting of the test device has been completed according to the testing results each time. When the calibration test pattern 300 in the calibration test piece 50 can be clearly identified from the eddy current testing result of the calibration test piece 50, it means that the adjustment of the parameter value setting of the test device has been completed. Next, the test device that has completed the adjustment can be further used for performing eddy current testing on the finished recuperative heat exchanger to be tested, so as to detect whether the welds of the finished recuperative heat exchanger are in the normal welding state on the premise of not destructing the welds. Conversely, the calibration test pattern 300 in the calibration test piece 50 cannot be clearly identified from the eddy current testing result of the calibration test piece 50, the tester may adjust the parameter values of the test device according to the testing result until the calibration test pattern 300 in the calibration test piece 50 can be clearly identified from the eddy current testing result of the calibration test piece 50. In other words, the calibration test piece 50 described in this application can be used in an eddy current testing procedure of the recuperative heat exchanger, especially in a stage of the parameter value setting in the eddy current testing procedure. More specifically, first, the calibration test piece 50 may be scanned by a detecting element (e.g., an eddy current array probe) of the test device; then, the test device may display a result of this scan (e.g., an oscillogram); next, the parameter value setting of the test device (e.g., voltage magnitude display level range of an eddy current signal, impedance plane display range and phase angle, but not limited thereto) may be adjusted according to the result of this scan until the calibration test pattern 300 in the calibration test piece 50 can be clearly identified from the scan result; and finally, the finished recuperative heat exchanger to be tested may be subjected to eddy current testing by the test device that has completed the adjustment, so as to detect whether the welds of the finished recuperative heat exchanger are in the normal welding state on the premise of not destructing the welds.

Thereby, after the flaw shape (i.e., the calibration test pattern 300) in the calibration test piece 50 is known, the tester may continuously adjust the voltage magnitude display level range of the eddy current signal, the impedance plane display range, the phase angle and other parameters obtained by scanning. Since the eddy current signal is not absolute and voltage values vary at different phase angles, the tester needs to make adjustments by trial and error until the appropriate phase angle and a voltage value range of the flaw signal are found. At this time, the calibration test pattern 300 in the calibration test piece 50 can be clearly identified by the tester, so that the tester can scan and test the finished recuperative heat exchanger to be tested with the adjusted parameters subsequently.

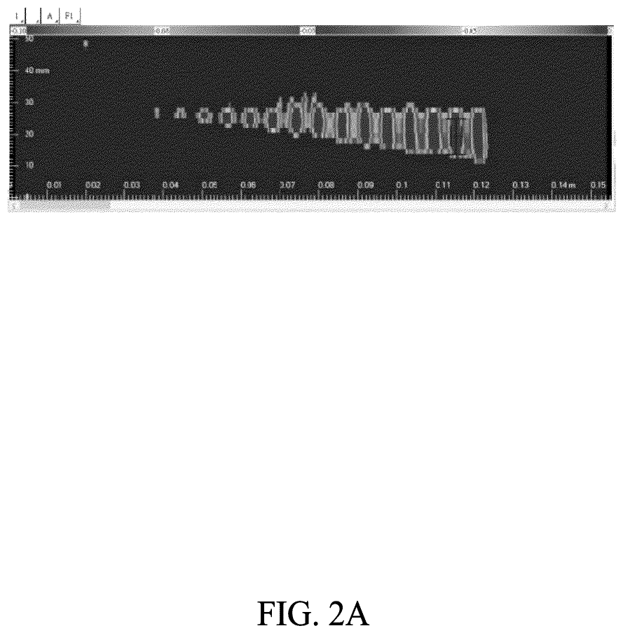

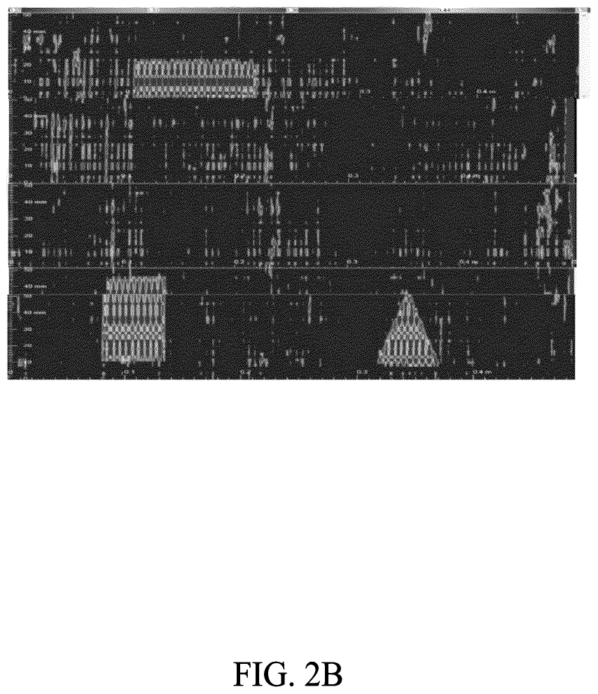

Referring to FIG. 2A, FIG. 2A is an oscillogram of a testing signal of the calibration test piece for eddy current testing according to an embodiment of this application. The specific configuration of the calibration test piece is shown in FIG. 1A to FIG. 1C, and the material of the metal base plate of the calibration test piece is nickel alloy 800.

As shown in FIG. 2A, when the calibration test pattern in the calibration test piece can be clearly identified from the eddy current testing result of the calibration test piece, it means that the adjustment of the parameter value setting of the test device has been completed and the test device that has completed the adjustment can be further used for performing eddy current testing of the finished recuperative heat exchanger to be tested, so as to detect whether the welds of the finished recuperative heat exchanger are in the normal welding state on the premise of not destructing the welds.

Referring to FIG. 2B, FIG. 2B is an oscillogram of a testing signal of an actual test object according to an embodiment of this application. The actual test object is a recuperative heat exchanger, and the material of the metal base plate of the recuperative heat exchanger is nickel alloy 800.

As shown in FIG. 2B, since the adjustment of the parameter value setting of the test device has been completed through the aforementioned calibration test piece, the test device that has completed the adjustment can detect the flaw of the recuperative heat exchanger, i.e., the part of the welds between the metal base plate and the metal wavy finned sheet of the recuperative heat exchanger that is in the abnormal welding state. Then, the display result of FIG. 2B may be marked on the actual recuperative heat exchanger.

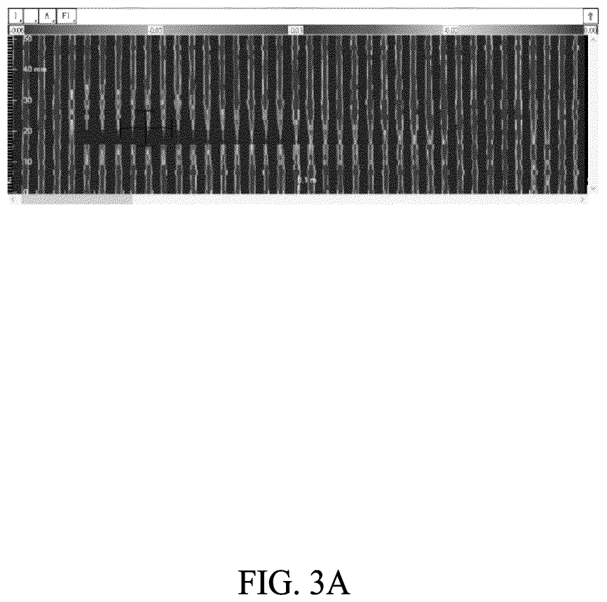

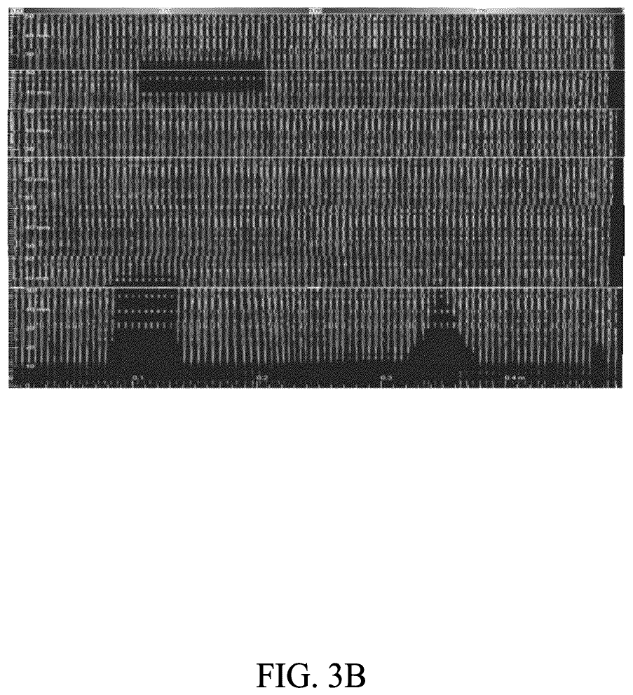

Referring to FIG. 3A, FIG. 3A is an oscillogram of a testing signal of the calibration test piece for eddy current testing according to another embodiment of this application. The specific configuration of the calibration test piece is shown in FIG. 1A to FIG. 1C, and the material of the metal base plate of the calibration test piece is nickel alloy 625.

As shown in FIG. 3A, when the calibration test pattern in the calibration test piece can be clearly identified from the eddy current testing result of the calibration test piece, it means that the adjustment of the parameter value setting of the test device has been completed and the test device that has completed the adjustment can be further used for performing eddy current testing of the finished recuperative heat exchanger to be tested, so as to detect whether the welds of the finished recuperative heat exchanger are in the normal welding state on the premise of not destructing the welds.

Referring to FIG. 3B, FIG. 3B is an oscillogram of a testing signal of an actual test object according to another embodiment of this application. The actual test object is a recuperative heat exchanger, and the material of the metal base plate of the recuperative heat exchanger is nickel alloy 625.

As shown in FIG. 3B, since the adjustment of the parameter value setting of the test device has been completed through the aforementioned calibration test piece, the test device that has completed the adjustment can detect the flaw of the recuperative heat exchanger, i.e., the part of the welds between the metal base plate and the metal wavy finned sheet of the recuperative heat exchanger that is in the abnormal welding state. Then, the display result of FIG. 3B may be marked on the actual recuperative heat exchanger.

The calibration test piece described in this application can not only effectively improve the efficiency of adjusting the parameter value setting of the test device, but also effectively improve the speed and accuracy of eddy current testing of the finished recuperative heat exchanger to be tested.

Further, with the calibration test piece described in this application, the probability of detection (POD), which is used to indicate the probability of detecting a flaw, can reach 100% (the calculation result after 8 groups of test pieces are actually tested), and the false call probability (FCP), which is used to indicate the probability that a non-flaw is detected as a flaw, is 2.82% on average (the calculation result after 8 groups of test pieces are actually tested). In other words, the calibration test piece described in this application can reach a confidence level of 99% according to ASME Section V specification.

This application has been further described through the above embodiments and accompanying drawings, but those of ordinary skill in the art to which this application belongs can still make many modifications and changes without departing from the scope and spirit set forth in the claims of this application. Therefore, the scope of protection of this application shall still be defined by the claims, and shall not be limited by the contents disclosed in the specification.

What is claimed is:

1. A calibration test piece for eddy current testing, comprising:
a metal base plate;
a metal wavy finned sheet, welded on the metal base plate, wherein the metal wavy finned sheet comprises a plurality of metal crests and a plurality of metal troughs, and the plurality of metal crests and the plurality of metal troughs respectively extend in parallel along an extension direction parallel to the metal base plate; and
a calibration test pattern, formed between the metal wavy finned sheet and the metal base plate, wherein in an area of the calibration test pattern, the metal wavy finned sheet and the metal base plate are in an abnormal welding state,
wherein the calibration test pattern has a hypotenuse, and the hypotenuse forms an included angle with the extension direction.

2. The calibration test piece according to claim 1, wherein the calibration test pattern further has a first side and a second side, the first side being parallel to the extension direction, and the second side being perpendicular to the extension direction.

3. The calibration test piece according to claim 1, wherein the calibration test pattern is a triangle.

4. The calibration test piece according to claim 1, wherein the metal base plate is a metal flat plate or a metal bent plate.

5. The calibration test piece according to claim 1, wherein the calibration test piece is used in an eddy current testing procedure of a recuperative heat exchanger.
